(19) United States
(12) Patent Application Publication
(10) Pub. No.: US 2018/0266228 A1
(43) Pub. Date: Sep. 20, 2018

(54) SYSTEM AND METHOD OF EXTRACTING HYDROCARBONS FROM A WELLBORE FORMED IN A SUBTERRANEAN ROCK FORMATION

(71) Applicant: General Electric Company, Schenectady, NY (US)

(72) Inventors: Andrew Jacob Gorton, Oklahoma City, OK (US); Mark H. Holtz, Keystone, CO (US); Bill James Johnson, Edmond, OK (US); Venkat Subramaniam Venkataramani, Clifton Park, NY (US); John Thomas Leman, Schenectady, NY (US); Peter John Bonitatibus, JR., Saratoga Springs, NY (US); Davide Simone, Saratoga Springs, NY (US)

(21) Appl. No.: 15/921,158

(22) Filed: Mar. 14, 2018

Related U.S. Application Data
(60) Provisional application No. 62/471,709, filed on Mar. 15, 2017.

(51) Int. Cl. E21B 43/267; C09K 8/80

(52) U.S. Cl. CPC E21B 43/267; C09K 8/80

(57) ABSTRACT

A method of extracting hydrocarbons from a wellbore formed in a subterranean rock formation. The wellbore includes at least one fracture extending therefrom. The method includes forming a particle-free treatment fluid that includes an uncured, particle-free proppant material, and injecting the particle-free treatment fluid into the wellbore and towards the at least one fracture. The uncured, particle-free proppant material is configured to cure in-situ when positioned within the at least one fracture.

### CROSS-REFERENCE TO RELATED APPLICATIONS

This application claims priority to U.S. Provisional Application No. 62/471,709 filed Mar. 15, 2017, which is hereby incorporated by reference in its entirety.

### BACKGROUND

The present disclosure relates generally to hydraulic fracturing and, more specifically, to systems and methods that utilize a particle-free proppant material for use in creating and holding fractures open in an oil and gas bearing rock formation.

Hydraulic fracturing, commonly known as fracing, is a technique used to release petroleum, natural gas, and other hydrocarbon-based substances for extraction from underground reservoir rock formations. The technique includes drilling a wellbore into the rock formations, and pumping a treatment fluid into the wellbore, which causes fractures to form in the rock formations and allows for the release of trapped substances to be produced from these subterranean natural reservoirs. At least some known fracturing systems utilize a process wherein a particle-based proppant slurry, including fracturing fluid (e.g., water) and particles (e.g. sand), is mixed and then pumped into the wellbore at elevated pressures. The particles provide support for maintaining the fractures in an open position, and also form a permeable medium that enables the trapped substances to be extracted therethrough. However, at least some known fractures are oriented vertically such that the particles tend to settle at the bottom of the fractures, thereby resulting in the lower portion of the fracture height being supported by the particles and limiting extraction of the trapped substances (i.e., hydrocarbons). In addition, the proppant material is subjected to increased loading and stress concentrations as the trapped substances are extracted from the rock formations.

### BRIEF DESCRIPTION

In one aspect, a method of extracting hydrocarbons from a wellbore formed in a subterranean rock formation is provided. The wellbore includes at least one fracture extending therefrom. The method includes forming a particle-free treatment fluid that includes an uncured, particle-free proppant material, and injecting the particle-free treatment fluid into the wellbore and towards the at least one fracture. The uncured, particle-free proppant material is configured to cure in-situ when positioned within the at least one fracture.

In another aspect, a system for use in extracting hydrocarbons from a wellbore formed in a subterranean rock formation is provided. The wellbore includes at least one fracture extending therefrom. The system includes at least one storage tank configured to store at least one constituent of a particle-free treatment fluid therein. The particle-free treatment fluid includes an uncured, particle-free proppant material. A particle-free fluid injection subsystem is coupled in flow communication with the at least one storage tank, and the particle-free fluid injection subsystem is configured to inject the particle-free treatment fluid into the wellbore. The uncured, particle-free proppant material is configured to cure in-situ when positioned within the at least one fracture.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic illustration of a hydraulic fracturing system;

FIG. 2 is a flow diagram illustrating an exemplary method of extracting hydrocarbons from a wellbore formed in a subterranean rock formation; and

FIG. 3 is a diagram illustrating exemplary fluid injection schedules.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

Embodiments of the present disclosure relate to systems and methods that utilize a particle-free proppant material for use in holding fractures open in an oil and gas bearing rock formation. More specifically, the particle-free proppant material is injected into a wellbore and towards the subterranean rock formation in the form of a treatment fluid formed at a surface site located above the subterranean rock formation. The particle-free proppant material is in an uncured state before being injected into the wellbore. In addition, the particle-free treatment fluid is injected at an elevated pressure that facilitates creating and/or holding open fractures formed in the subterranean rock formation. The particle-free proppant material then cures when positioned within the fractures in-situ, and cures with a connected pore volume such that a high permeability pathway is formed that facilitates channeling trapped hydrocarbons therethrough. As such, injecting a hardening particle-free proppant material into the fractures facilitates holding the fractures open in a more spatially uniform, load-bearing, and efficient manner once the material has cured.

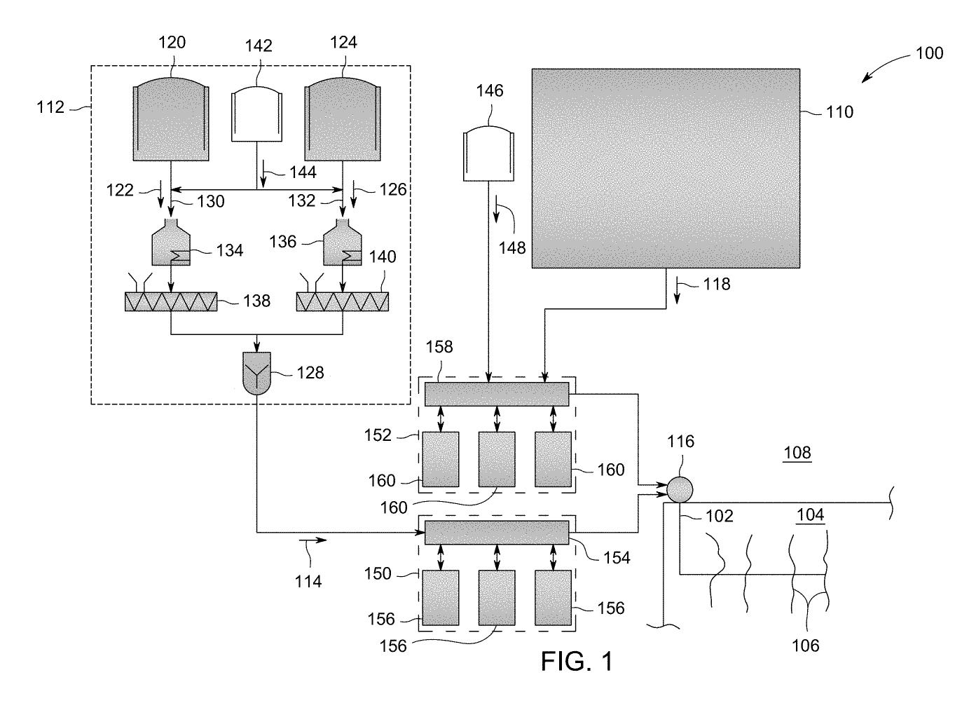

FIG. 1 is a schematic illustration of a hydraulic fracturing system 100 for use in extracting hydrocarbons from a wellbore 102 in a subterranean rock formation 104. More specifically, subterranean rock formation 104 includes at least one fracture 106 extending from wellbore 102. In the exemplary embodiment, hydraulic fracturing system 100 is located on a surface site 108 above subterranean rock formation 104, and includes a conventional fluid delivery system 110 and a particle-free delivery system 112. Particle-free proppant material delivery system 112 selectively channels a particle-free treatment fluid 114 towards a wellhead 116, and conventional fluid delivery system 110 selectively channels a conventional treatment fluid 118, including a particle-based proppant material, for example, towards wellhead 116 for injection of treatment fluid into wellbore 102, as will be described in more detail below. The order of injecting particle-free proppant material and other more traditional hydraulic fracturing fluids is not prescribed in any particular order and is a design consideration depending on many factors (e.g., economics, rock type, company stimulation approach).

Particle-free proppant material delivery system 112 includes at least one storage tank that stores at least one constituent of particle-free treatment fluid 114 therein. More specifically, particle-free proppant material delivery system 112 includes a first storage tank 120 that stores a first constituent 122 of particle-free treatment fluid 114 therein, and a second storage tank 124 that stores a second constituent 126 of particle-free treatment fluid 114 therein. As will be explained in more detail below, first constituent 122 and second constituent 126 are discharged from their respective storage tanks and combined to form particle-free treatment fluid 114. For example, in one embodiment, first storage tank 120 stores first constituent 122 including an uncured, particle-free proppant material therein, and second storage tank 124 stores an activator material that, when combined with first constituent 122, initiates curing of the uncured, particle-free proppant material. In an alternative embodiment, particle-free proppant material delivery system 112 includes more than two storage tanks, and the particle-free treatment fluid is formed by combining more than two constituents. Further, in an alternative embodiment, particle-free treatment fluid 114 including the uncured, particle-free proppant material is stored in a single storage tank, and the curing process is initiated based on reservoir temperature.

Any particle-free proppant material may be used in particle-free treatment fluid 114 that enables hydraulic fracturing system 100 to function as described herein. More specifically, the particle-free proppant material is selected based on one or more properties that facilitate its use in hydraulic fracturing operations. For example, in an uncured state, the particle-free proppant material preferably has a curing temperature defined within a range between about 48.9° C. (120° F.) and about 104.4° C. (220° F.), can be pumped at elevated pressures defined within a range between about 5,000 pounds per square inch (psi) (340.2 atm) and about 15,000 psi (1,020.7 atm), a viscosity of less than about 400 centipoise, and has a curing time greater than the time it takes for the particle-free proppant material to settle within subterranean rock formation 104. In one embodiment, the curing time is greater than about 1 hour. In a cured state, the particle-free proppant material preferably has a crush strength defined within a range between about 8,000 psi (544.4 atm) and about 12,000 psi (816.6 atm), a permeability greater than about 100 Darcies, and a porosity of greater than about 30 percent. In one embodiment, first constituent 122 is a ceramic-based material.

Alternatively, the particle-free proppant material includes, but is not limited to, a thermoplastic polymer with water-soluble salts/binders that act as pore formers, a thermosettable liquid polymer system, a gellable inorganic polymer with a supercritical gas pore former, a polysaccharide-based gellable slurry, an inorganic (silicate, phosphate, phosphosilicate, aluminate, alumino silicate, oxychloride, oxysulfate) cement, multication phaosphate solutions, and a polysialate/polyphosphate-bindered three-dimensional network system.

As described above, in the exemplary embodiment, first constituent 122 and second constituent 126 are combined to form particle-free treatment fluid 114. More specifically, particle-free proppant material delivery system 112 includes a mixer 128 coupled in flow communication with first storage tank 120 and second storage tank 124. Mixer 128 receives and combines first constituent 122 and second constituent 126, and discharges particle-free treatment fluid 114 therefrom.

Moreover, in one embodiment, particle-free proppant material delivery system 112 includes at least one conduit extending from the at least one storage tank. More specifically, a first conduit 130 extends from first storage tank 120 and a second conduit 132 extends from second storage tank 124. A first heater 134 is coupled along first conduit 130 and a second heater 136 is coupled along second conduit 132. First heater 134 and second heater 136 heat first constituent 122 and second constituent 126 before being channeled towards mixer 128 and before being injected into wellbore 102. Heating first constituent 122 and second constituent 126 facilitates curing the uncured, particle-free proppant material. In addition, independently heating first constituent 122 and second constituent 126 with first heater 134 and second heater 136, respectively, enables each constituent to be heated to different temperatures. In an alternative embodiment, a single heater (not shown), either in addition to or as an alternative to first heater 134 and second heater 136, is positioned downstream from mixer 128 for heating particle-free treatment fluid 114. Moreover, a first transport mechanism 138 is coupled downstream from first heater 134 and a second transport mechanism 140 is coupled downstream from second heater 136. First transport mechanism 138 and second transport mechanism 140 facilitate conveying first constituent 122 and second constituent 126 towards mixer 128. While shown as including heaters coupled upstream from transport mechanisms, it should be understood that the equipment of particle-free proppant material delivery system 112 may be arranged in any configuration that enables hydraulic fracturing system 100 to function as described herein.

Hydraulic fracturing system 100 further includes a third storage tank 142 that stores a flushing fluid 144 therein. Third storage tank 142 is coupled in flow communication with first conduit 130 and second conduit 132, and selectively channels flushing fluid 144 through first conduit 130 and second conduit 132. In addition, flushing fluid 144 flows through at least first heater 134 and second heater 136, first transport mechanism 138 and second transport mechanism 140, and mixer 128 such that a residual amount of the uncured, particle-free proppant material is removed therefrom. As such, the uncured, particle-free proppant material is removed from particle-free proppant material delivery system 112, and the equipment of hydraulic fracturing system 100 up to wellbore 102, before it has time to cure, thereby preserving the flowpath for channeling fluid from first storage tank 120 and second storage tank 124 towards wellhead 116 and into subterranean rock formation 104.

Hydraulic fracturing system 100 further includes a fourth storage tank 146 that stores a pad fluid 148 therein. Pad fluid 148 is any fluid that enables hydraulic fracturing system 100 to function as described herein. In one embodiment, pad fluid 148 is water with a friction reducer.

In the exemplary embodiment, hydraulic fracturing system 100 includes a particle-free fluid injection subsystem 150 and a conventional fluid injection subsystem 152. Particle-free fluid injection subsystem 150 is coupled downstream from particle-free proppant material delivery system 112, and conventional fluid injection subsystem 152 is coupled downstream from conventional fluid delivery system 110 and fourth storage tank 146. Particle-free fluid injection subsystem 150 includes a first manifold 154 and at least one pump 156, and conventional fluid injection subsystem 152 includes a second manifold 158 and at least one pump 160.

In operation, as will be described in more detail below, first manifold 154 receives particle-free treatment fluid 114 therein for subsequent injection towards wellhead 116 and into wellbore 102. In addition, second manifold 158 receives one of conventional treatment fluid 118 and pad fluid 148 therein for subsequent injection towards wellhead 116 and into wellbore 102. Pumps 156 are coupled in flow communication with first manifold 154, and are operable for channeling the fluid contained within first manifold 154 towards wellhead 116 and into wellbore 102. Likewise, pumps 160 are coupled in flow communication with second manifold 158, and are operable for channeling the fluid contained within second manifold 158 towards wellhead 116 and into wellbore 102. Particle-free fluid injection subsystem 150 and conventional fluid injection subsystem 152 operate independently from each other. As such, potential buildup of residual cured, particle-free proppant material in conventional fluid injection subsystem 152 is avoided. In an alternative embodiment, the same fluid injection subsystem is used to inject particle-free treatment fluid 114, conventional treatment fluid 118, and pad fluid 148 into wellbore 102.

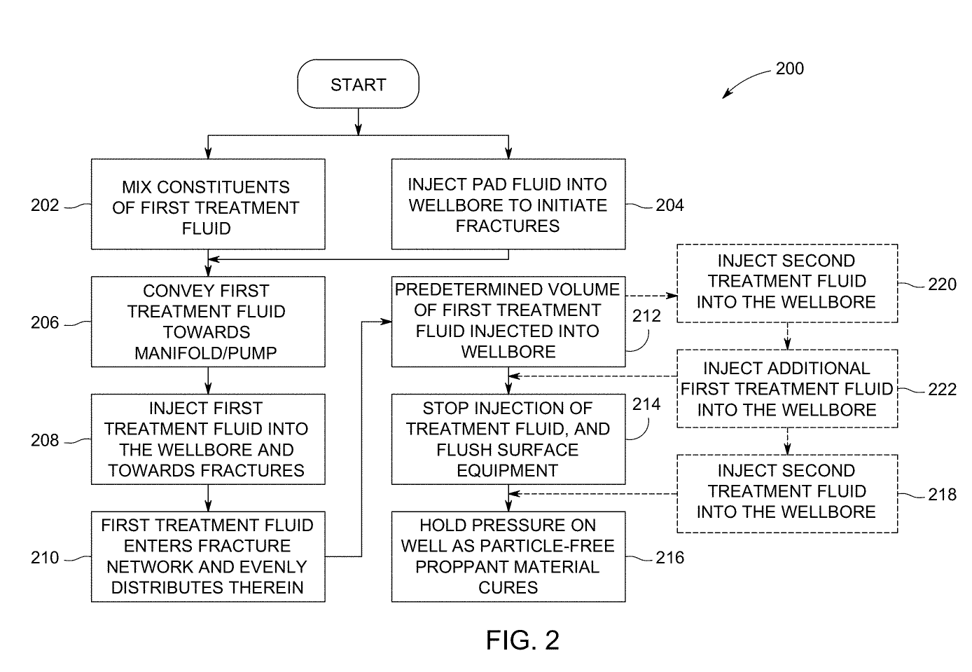

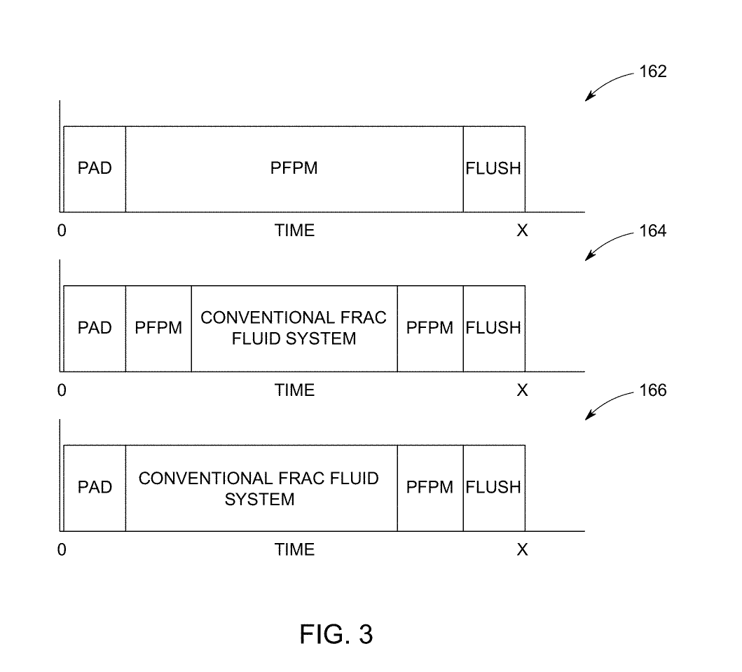

FIG. 2 is a flow diagram illustrating an exemplary method 200 of extracting hydrocarbons from wellbore 102 formed in subterranean rock formation 104 (both shown in FIG. 1), and FIG. 3 is a diagram illustrating exemplary fluid injection schedules. More specifically, referring to FIG. 3, the diagram includes a first fluid injection schedule 162, a second fluid injection schedule 164, and a third fluid injection schedule 166. Referring to FIG. 3, method 200 includes mixing 202 constituents of particle-free treatment fluid 114 (shown in FIG. 1) to form particle-free treatment fluid 114, and injecting 204 pad fluid 148 into wellbore 102 to initiate fractures in subterranean rock formation 104. Particle-free treatment fluid 114 is then conveyed 206 towards manifold 154 and pump 152 (both shown in FIG. 1), and particle-free treatment fluid 114 is injected 208 into wellbore 102 and towards the fractures. Particle-free treatment fluid 114 enters 210 the fracture network formed in subterranean rock formation 104 and evenly distributes therein. More specifically, a predetermined volume of particle-free treatment fluid 114 is injected 212 into wellbore 102. The predetermined volume is selected to facilitate distributing particle-free treatment fluid 114 within a full height of the fractures. Injection of particle-free treatment fluid 114 is then stopped 214 and the surface equipment is flushed (see first fluid injection schedule 162), and pressure is held 216 on the well for a period of time that enables the uncured, particle-free proppant material of particle-free treatment fluid 114 to cure in-situ when positioned within fracture 106 (shown in FIG. 1). As such, fracture 106 is held open and the cured, particle-free proppant material forms a permeable pathway for extracting hydrocarbons from subterranean rock formation 104.

In an alternative embodiment, conventional treatment fluid 118 (shown in FIG. 1) is injected 218 into wellbore 102 after injection 208 of particle-free treatment fluid 114 into wellbore 102 and towards fracture 106 (see second injection schedule 164). For example, conventional treatment fluid 118 is injected 218 for a greater period of time, and at a greater volumetric capacity than particle-free treatment fluid 114. As such, the cost of injecting potentially expensive particle-free proppant material into wellbore 102 is reduced. In addition, injecting 208 particle-free treatment fluid 114 before conventional treatment fluid 118 facilitates ensuring particle-free treatment fluid 114 occupies the outermost portions of fractures 106, thereby holding fractures 106 in an open position. In a further alternative embodiment, particle-free treatment fluid 114 is injected 208 into wellbore 102, conventional treatment fluid 118 is injected 220 into wellbore 102, and additional particle-free treatment fluid 114 is injected 222 into wellbore 102 (see second injection schedule 164). As such, the cost of injecting potentially expensive particle-free proppant material into wellbore 102 is reduced, and the particle-free proppant material of the additional particle-free treatment fluid 114 is positioned in an area of wellbore 102 having comparatively high closure stress relative to other portions of wellbore 102. In a further alternative embodiment, conventional treatment fluid 118 is injected 220 into wellbore 102, and then particle-free treatment fluid 114 is injected 222 into wellbore 102 (see third injection schedule 166).

The system and method described herein facilitate increasing the extraction of hydrocarbons from a subterranean rock formation by increasing surface area contact between side walls of a fracture and a permeable medium positioned within the fracture. The particle-free proppant material is less susceptible to settling out of vertically oriented fractures when compared to conventional particle-based treatment fluids, thereby facilitating proppant from the top to the bottom of the fracture, placement of proppant material farther from the wellbore, and even distribution of fracture closure stresses. In addition, the particle-free proppant material described herein has favorable crush strength properties such that fracture conductivity is substantially maintained as hydrocarbons are extracted from the fractures.

An exemplary technical effect of the apparatus and method described herein includes at least one of: (a) increasing hydrocarbon recovery from a subterranean rock formation over the life of a well; (b) holding fractures open in a more uniform and evenly distributed manner; and (c) reducing water and energy usage in hydraulic fracturing operations.

Exemplary embodiments of a system and method of extracting hydrocarbons from a subterranean rock formation, and related components are described above in detail. The system is not limited to the specific embodiments described herein, but rather, components of systems and/or steps of the methods may be utilized independently and separately from other components and/or steps described herein. For example, the configuration of components described herein may also be used in combination with other processes, and is not limited to practice with only hydraulic fracturing operations and related methods as described herein. Rather, the exemplary embodiment can be implemented and utilized in connection with many applications where in-situ curing of a porous medium into an enclosed space is desired.

Although specific features of various embodiments of the present disclosure may be shown in some drawings and not in others, this is for convenience only. In accordance with the principles of embodiments of the present disclosure, any feature of a drawing may be referenced and/or claimed in combination with any feature of any other drawing.

This written description uses examples to disclose the embodiments of the present disclosure, including the best mode, and also to enable any person skilled in the art to practice embodiments of the present disclosure, including making and using any devices or systems and performing any incorporated methods. The patentable scope of the embodiments described herein is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of extracting hydrocarbons from a wellbore formed in a subterranean rock formation, the wellbore including at least one fracture extending therefrom, said method comprising:
forming a particle-free treatment fluid that includes an uncured, particle-free proppant material; and
injecting the particle-free treatment fluid into the wellbore and towards the at least one fracture, wherein the uncured, particle-free proppant material is configured to cure in-situ when positioned within the at least one fracture.

2. The method in accordance with claim 1 further comprising injecting a pad fluid into the wellbore before injection of the particle-free treatment fluid into the wellbore.

3. The method in accordance with claim 1 further comprising injecting a conventional treatment fluid into the wellbore, the conventional treatment fluid including a particle-based proppant material.

4. The method in accordance with claim 3, wherein injecting a conventional treatment fluid comprises injecting the conventional treatment fluid into the wellbore after injection of the particle-free treatment fluid into the wellbore.

5. The method in accordance with claim 3 further comprising:
injecting the particle-free treatment fluid into the wellbore before injection of the conventional treatment fluid into the wellbore; and
injecting additional particle-free treatment fluid into the wellbore after the conventional treatment fluid is injected into the wellbore.

6. The method in accordance with claim 1, wherein forming a particle-free treatment fluid comprises forming the particle-free treatment fluid from at least two constituents, wherein the at least two constituents are combined before injection of the particle-free treatment fluid into the wellbore.

7. The method in accordance with claim 6, wherein forming the particle-free treatment fluid comprises forming the particle-free treatment fluid from a first constituent of the at least two constituents, wherein the first constituent includes a ceramic-based material.

8. The method in accordance with claim 6, wherein forming the particle-free treatment fluid comprises combining the at least two constituents at a surface site located above the subterranean rock formation.

9. The method in accordance with claim 1 further comprising heating the particle-free treatment fluid before injection of the particle-free treatment fluid into the wellbore.

10. The method in accordance with claim 9, wherein the particle-free treatment fluid is formed from at least two constituents, said method further comprising heating at least one of the at least two constituents before injection of the particle-free treatment fluid into the wellbore.

11. The method in accordance with claim 1, wherein surface equipment is used to inject the particle-free treatment fluid into the wellbore, said method further comprising:
stopping injection of the particle-free treatment fluid into the wellbore; and
flushing the surface equipment with a flushing fluid such that a residual amount of the uncured, particle-free proppant material is removed therefrom.

12. A system for use in extracting hydrocarbons from a wellbore formed in a subterranean rock formation, the wellbore including at least one fracture extending therefrom, said system comprising:
at least one storage tank configured to store at least one constituent of a particle-free treatment fluid therein, the particle-free treatment fluid comprising an uncured, particle-free proppant material; and
a particle-free fluid injection subsystem coupled in flow communication with said at least one storage tank, said particle-free fluid injection subsystem configured to inject the particle-free treatment fluid into the wellbore, wherein the uncured, particle-free proppant material is configured to cure in-situ when positioned within the at least one fracture.

13. The system in accordance with claim 12, wherein said at least one storage tank comprises:
a first storage tank configured to store a first constituent of the particle-free treatment fluid therein; and
a second storage tank configured to store a second constituent of the particle-free treatment fluid therein.

14. The system in accordance with claim 13 further comprising a mixer configured to combine the first constituent and the second constituent of the particle-free treatment fluid before injection of the particle-free treatment fluid into the wellbore.

15. The system in accordance with claim 13, wherein said first storage tank is configured to store the first constituent that comprises a ceramic-based material therein.

16. The system in accordance with claim 12 further comprising:
at least one conduit extending from said at least one storage tank; and
a third storage tank configured to store a flushing fluid therein, said third storage tank coupled in flow communication with said at least one conduit, and said third storage tank configured to selectively channel the flushing fluid through said at least one conduit such that a residual amount of the uncured, particle-free proppant material is removed therefrom.

17. The system in accordance with claim 12 further comprising:
at least one conduit extending from said at least one storage tank; and
a heater coupled along said at least one conduit, said heater configured to heat at least one of the at least one constituent or the particle-free treatment fluid before being injected into the wellbore.

18. The system in accordance with claim 12 further comprising a conventional fluid delivery system configured to inject a conventional treatment fluid into the wellbore, the conventional treatment fluid comprising a particle-based proppant material.

19. The system in accordance with claim 18 further comprising a conventional fluid injection subsystem configured to inject the conventional treatment fluid into the wellbore, wherein said conventional fluid injection subsystem operates independently of said particle-free fluid injection subsystem.

20. The system in accordance with claim 19 further comprising a fourth storage tank configured to store a pad fluid therein, said fourth storage tank coupled in flow communication with said conventional fluid injection subsystem configured to inject the pad fluid into the wellbore.
